(19) United States
(12) Patent Application Publication
(10) Pub. No.: US 2006/0213054 A1
(43) Pub. Date: Sep. 28, 2006

(54) Method of producing and dimensioning a piezoelectric transformer

(75) Inventors: Francois Costa, Cachan (FR); Dejan Vasic, Paris (FR); Emmanuel Sarraute, Champs Sur Mame (FR)

Correspondence Address: MILLER, MATTHIS & HULL, ONE NORTH FRANKLIN STREET, SUITE 2350, CHICAGO, IL, 60606, US

(73) Assignees: CENTRE NATIONAL DE LA RECHERCHE SCIENTIFIQUE-CNRS, PARIS (FR); ECOLE NORMALE SUPERIEURE DE CACHAN

(21) Appl. No.: 10/555,826

(22) PCT Filed: Apr. 29, 2004
(86) PCT No.: PCT/FR04/01040

§ 371 Date: Nov. 7, 2005

(30) Foreign Application Priority Data
May 7, 2003 (FR) 03/05599

(51) Int. Cl. G11B 5/127; H04R 31/00

(52) U.S. Cl. 29/603.13; 29/603.08

(57) ABSTRACT

A method of making a piezoelectric transformer (100) comprising a primary plate (4) and a secondary plate (8), in which a step a) is implemented during which, on the basis of an equivalent model of the transformer (100), a geometrical parameter for the plates or a physical parameter for a material constituting the plates is determined, while taking account of an expression for the heat dissipated by losses in the transformer.

The present invention relates to methods of making piezoelectric transformers.

More particularly, the invention relates to a method of making a piezoelectric transformer comprising a primary plate and a secondary plate, in which method a step a) is implemented during which, starting from an equivalent model of the transformer, at least one parameter selected from among geometrical parameters of the plates and physical parameters of a material constituting the plates is determined.

Such methods have been known at least since Mason developed an equivalent electrical model of a plate of piezoelectrical material. For example, there can be found in “Piezoelectric technology primer” by James R. Phillips, constituting Appendix B of the document “Ultracompact LCD backlight inverters”, a model of a piezoelectric transformer enabling geometrical parameters of the transformer and physical parameters of the material(s) constituting the selected transformer to be associated with the electrical parameters of the transformer used as such as in a circuit.

A transformer dimensioned in this way can nevertheless be unusable since it might be discovered a posteriori that the losses in the transformer lead to malfunctions in the transformer and/or in the electronic circuits adjacent to the transformer.

An object of the invention is to avoid that type of malfunction.

To this end, the invention provides a method which in addition to possessing the characteristics specified above, is characterized by the fact that during step a), account is taken of an expression for the heat dissipated due to losses in the transformer.

By means of these dispositions, it can be ensured that the transformer and the adjacent electronic circuits are not subjected to unfavorable conditions, regardless of their utilization conditions.

In preferred embodiments of the invention, recourse may optionally also be had to one or more of the following dispositions:

estimating as a function of said geometrical and physical parameters:
the losses of the transformer, and
a maximum acceptable temperature rise,
determining an operating range for the transformer corresponding to a condition whereby the transformer losses are less than a maximum acceptable quantity of heat corresponding to said temperature rise; and
determining at least the ratio of the thicknesses of the first and second plates and the area of at least one of the plates for an operating point selected in said operating range of the transformer;

the losses of the transformer are estimated as being
P₂(1−η)/η
where P₂ is the power transmitted by the transformer, η is the efficiency of the transformer, and where P₂ and η are expressed as a function of said parameters;

said quantity of dissipated heat is estimated as being
h_{c}SΔθ
where h_{c} is a coefficient specific to a material constituting the transformer, S is a heat exchange area that is a function in particular of the geometrical parameters of the plates, and Δθ is said maximum acceptable temperature rise;

said operating range extends between two limit operating points corresponding to losses that are substantially equal to said maximum acceptable quantity of heat;

an operating point is selected corresponding to a minimum area for at least one plate and to said maximum acceptable quantity of heat;

a characteristic of the model selected from efficiency, gain, power transmitted by the transformer, and any combination thereof, is expressed as a function of the operating point, and the operating point is selected as being an intermediate operating point corresponding to a given value for said characteristic;

the selected operating point is the point corresponding to an optimum value for said characteristic;

the transformer is to present at least one known characteristic selected from at least the gain, the transmitted power, the efficiency, and combinations thereof, and a system of equations is solved that comprises at least said known characteristic and an unknown parameter of the transformer for said selected operating point;

the transformer is designed to be powered by a primary electrical signal at a power supply frequency, a total thickness for the transformer is determined so that the power frequency is a mechanical resonant frequency of the transformer, and the thickness of each plate is determined on the basis of the total thickness and the ratio of the thicknesses;

a material for constituting at least one plate is selected by implementing successively the steps of the method for at least two distinct materials having known physical parameters;

the method further comprises the following steps:

b) assembling said two plates on either side of an intermediate layer of the transformer, said intermediate layer comprising an electrically insulating material; and

c) applying primary and secondary metallization to said plates, the primary metallization being for connection to a primary circuit and the secondary metallization being for connection to a secondary circuit;

said intermediate layer comprises an electrostatic screen;

the primary and secondary plates are respectively integrated in first and second layers made in a substrate of material selected from printed circuit material, ceramic material, and semiconductor material, and respectively supporting a primary circuit and a secondary circuit, the first and second layers being disposed respectively on either side of an intermediate circuit layer having at least a portion that forms the intermediate layer of the transformer; and

the intermediate layer of the transformer is mounted on a rigid support secured to an electronic circuit medium supporting said primary circuit and said secondary circuit.

Other characteristics and advantages of the invention appear from the following description of an embodiment thereof, given by way of non-limiting example and with reference to the accompanying drawings.

In the drawings:

FIG. 1 is a diagrammatic perspective view of a piezoelectric transformer;

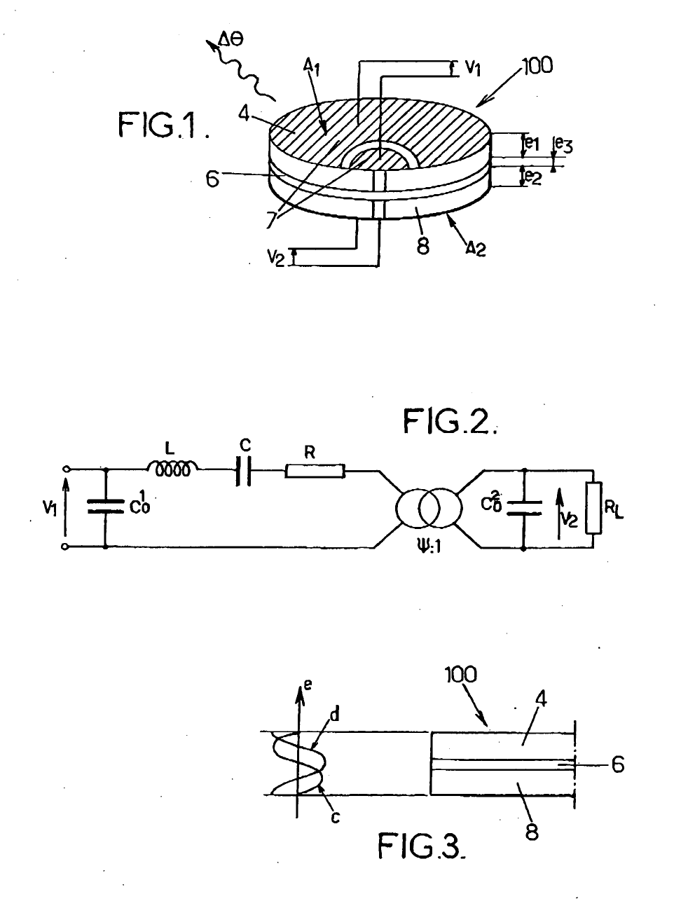

FIG. 2 is a simplified electrical circuit diagram of the transformer shown in FIG. 1;

FIG. 3 is a diagrammatic view showing the thickness vibration mode of the piezoelectric transformer of the FIG. 1 electronic circuit;

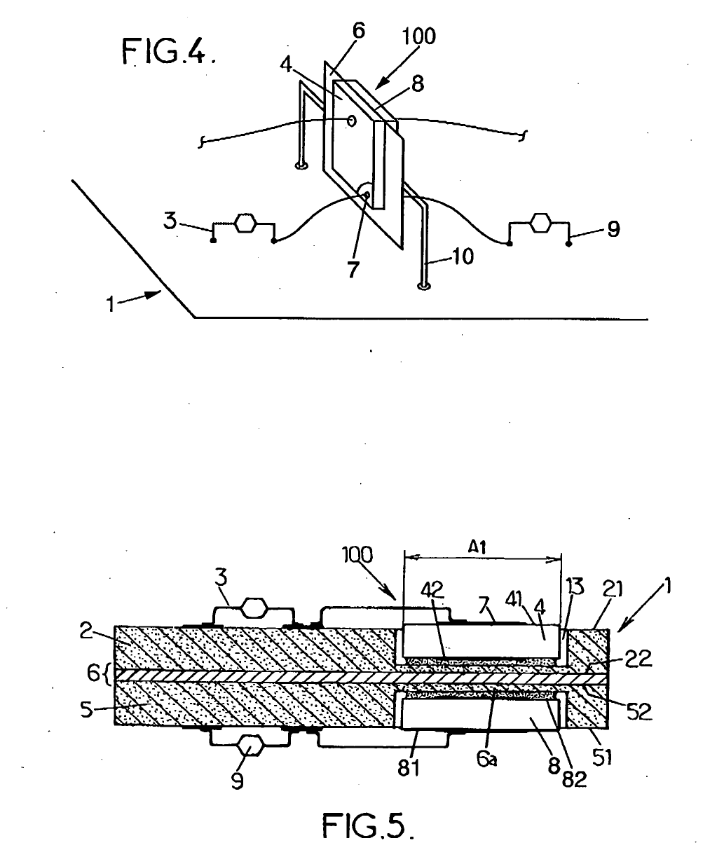

FIG. 4 shows a first embodiment of a piezoelectric transformer; and

FIG. 5 is a diagrammatic section through a second embodiment of a piezoelectric transformer.

In the various figures, elements that are identical or similar are designated by the same references.

FIG. 1 shows a piezoelectric transformer 100 constituted by a primary plate 4, a secondary plate 8, and an insulating intermediate layer 6.

The primary and secondary plates 4 and 8 are made, for example, out of lead zircono-titanate (PZT), being generally plane and circular or rectangular in shape, e.g. having respective areas A₁ and A₂ and thicknesses e₁, e₂.

The respective areas A₁ and A₂ of the primary and secondary plates 4 and 8 are substantially equal. However the respective thicknesses e₁ and e₂ of the primary and secondary plates 4 and 8 may be different.

The primary and secondary plates 4 and 8 are also partially covered in metallization 7 enabling electrical contacts to be placed thereon, e.g. on their outside faces.

The primary plate 4 is also biased so as to vibrate across its thickness when it is subjected to alternating electric current.

The primary and secondary plates 4 and 8 are spaced apart by about 0.1 millimeters (mm) to 1 mm. Between them there is the intermediate layer 6.

The power transfer delivered by the transformer 100 takes place by initially transforming electrical energy in the primary plate 4 into mechanical vibration in the thickness of the primary plate 4. This mechanical vibration generates vibration in the material(s) interposed between the primary and secondary plates 4 and 8, and in the secondary plate 8. The vibration is recovered from the secondary plate 8 in the form of electrical energy. Consequently, there is no electromagnetic coupling in this type of transformer, and that is favorable in terms of standards relating to electromagnetic compatibility.

The technical characteristics and performance of such a transformer 100 are closely associated with the physical and mechanical characteristics of the type of material used, and with the dimensions of the elements constituting the transformer 100.

If one has a priori knowledge of the type of application for which the transformer 100 is likely to be used, it can be dimensioned accordingly.

As shown in FIG. 1, a voltage V₁ is applied to the primary plate 4 of the transformer 100 (shown in purely illustrative manner as being cylindrical), having dimensions e₁ and A₁, and a voltage V₂ is obtained from the secondary plate 8 having dimensions e₂ and A₂. Account may optionally be taken of the intermediate layer of thickness e₃ and area A₃ while dimensioning the transformer.

As shown in FIG. 4, the transformer 100 forms a part of an electronic circuit 1, e.g. comprising a primary electronic component 3 supplying the voltage V₁ and a secondary electronic component 9 receiving the voltage V₂.

In operation under these conditions, the mechanical losses in the transformer 100 are converted into a dissipation of heat Δθ, and it can be advantageous to control this in order to ensure proper operation of the electronic circuit 1 as a whole. To achieve this, it is possible to apply the following modeling.

The electrical circuit diagram of FIG. 2 is used which is an equivalent circuit diagram for the transformer 100 in its resonant modes, as described in “Piezoelectric transformer operating in thickness extensional vibration and its application to switching converter”, PESC 94, Zaitsu et al.

This circuit is particularly adapted to a multilayer transformer operating at a frequency close to its resonant frequency, but the method of the invention can be applied to any other type of circuit representing a piezoelectric transformer, whether multilayer or otherwise, and should the need be felt, by going back to the Mason equivalent circuit for each plate.

In these circuits, the inductance, resistance, and capacitance values L, R, C, C¹₀, and C²₀ are associated with the physical and mechanical characteristics of the transformer 100. In a Mason model, coupling between the geometrical and physical characteristics of each plate is represented by a perfect transformer of gain Ψ₁ and Ψ₂ as expressed for example by:

$${Ψ}_{1} = \frac{{A}_{1}}{{e}_{1}} {e}_{33}$$

In the model shown, these two perfect transformers are grouped together as a single transformer with gain Ψ. The resistance R_{L} designates the resistance of the load on the transformer 100. To simplify, dimensioning details are given for a primary plate 4 and a secondary plate 8 made of identical materials, but these details can easily be transposed to primary and secondary plates 4 and 8 made of different materials.

Geometrically, each plate 4 or 8 is characterized by its thickness e₁, e₂ and by its area A₁, A₂. The material is physically characterized by its modulus of elasticity in its thickness c₃₃^{D}, by its permittivity ε₃₃^{S}, its piezoelectric coefficient e₃₃, its density ρ, its mechanical quality factor Qₘ, a coefficient for convection within the material h_{c}, and an electromechanical coupling coefficient kₜ.

In such a transformer, the physical and mechanical characteristics can be associated with the electrical properties of the equivalent circuit of FIG. 4 by the following equations:
C¹₀=ε₃₃^{S}×A₁/e₁
C²₀=ε₃₃^{S}×A₂/e₂
L=(e₁+e₂+e₃) e₁²ρ/8A₁e²₃₃
C=A₁e²₃₃/π²e₁c₃₃^{D}
R=[1/Qₘ]×(L/C)^{1/2}
ψ=A₁e₂/A₂e₁

Below, for purely illustrative purposes, a transformer is described having two plates with the same area A (A₁=A₂=A) and in which the thicknesses e₁ and e₂ are large compared with the thickness e₃ of the intermediate layer (e₁+e₂+e₃≈e₁+e₂), however the operations described below can perfectly well be performed for a general example.

In short-circuit, the transformer presents a resonant angular frequency ωₛ=1/(LC)^{1/2}.

To take account of the charge state of the transformer, an electrical quality factor Q can be introduced that depends of the equivalent resistance of the load R_{L} of the circuit to which the power is to be transmitted:
Q=1/R_{L}C²₀ω_{S}

It is also possible to use a ratio c that represents the fraction of the mechanical energy that can be converted into electrical energy in the secondary:
c=Ψ²C²₀/C=(π²/2kₜ²)(e₂/(e₁+e₂))−(e₁+e₂)/e₂

The resonant angular frequency ω_{R} of the entire circuit can be estimated by taking account of the load resistance, using the following expression associating ω_{R}, c, and ω_{S}:

$$\frac{{ω}_{R}^{2}}{{ω}_{S}^{2}} = \frac{1}{2} ( 1 + \frac{1}{c} - {Q}^{2} ) + \sqrt{\frac{1}{4} {( 1 + \frac{1}{c} - {Q}^{2} )}^{2} + {Q}^{2}}$$

As a function of these various circuit parameters and of the voltage V₁ and of the operating frequency ω_{R}, the power transmitted P₂, the gain G, and the efficiency η of the transformer 100 can be expressed as follows:

$$G = \frac{{V}_{2}}{{V}_{1}} \frac{Ψ}{\sqrt{{[ 1 - c ( \frac{{ω}_{R}^{2}}{{ω}_{S}^{2}} - 1 + \frac{Q}{{Q}_{m}} ) ]}^{2} + {[ \frac{c}{{Q}_{m}} \frac{{ω}_{R}}{{ω}_{S}} + cQ ( \frac{{ω}_{R}}{{ω}_{S}} - \frac{{ω}_{S}}{{ω}_{R}} ) ]}^{2}}}$$

$${P}_{2} = \frac{\frac{{V}_{2}}{{V}_{1}} c \frac{Q}{{Q}_{m}}}{{[ 1 - c ( \frac{{ω}_{R}^{2}}{{ω}_{S}^{2}} - 1 + \frac{Q}{{Q}_{m}} ) ]}^{2} + {[ \frac{c}{{Q}_{m}} \frac{{ω}_{R}}{{ω}_{S}} + cQ ( \frac{{ω}_{R}}{{ω}_{S}} - \frac{{ω}_{S}}{{ω}_{R}} ) ]}^{2}}$$

$$and$$

$$η = \frac{1}{1 + \frac{Q}{{Q}_{m}} c ( \frac{1}{{Q}^{2}} \frac{{ω}_{R}^{2}}{{ω}_{S}^{2}} )}$$

The various sources of losses lead to the structure becoming heated. Also, the properties of the piezoelectric material are sensitive to the surrounding temperature. It can therefore be desirable to dimension a transformer so that its temperature rise in operation is less than some predefined value Δθ. For example, heating losses can be represented by h_{c}SΔθ, where S is the area of heat exchange with the outside (S=2A=A₁+A₂ for a thin transformer), or by any other appropriate expression. The temperature rise will not exceed Δθ providing the following condition is satisfied:
P₂(1−η)/η<h_{c}SΔθ

Replacing η by the above expression gives:

$$1 - \frac{{h}_{c} S Δ θ}{{P}_{2}} \frac{{Q}_{m}}{c} \frac{1}{Q} + \frac{{ω}_{R}^{2}}{{ω}_{S}^{2}} \frac{1}{{Q}^{2}} < 0$$

which is a function of Q representing the influence of the circuit to be driven via the secondary of the transformer.

When using such a system of equations, the choice of an operating point Q for the circuit makes it possible to determine the geometrical and physical properties of the transformer. By way of example, this operating point may be conditioned by requirements relating to the maximum volume of the transformer, optimum performance, e.g. in terms of gain, power transmission, efficiency, a compromise between these various requirements, etc. Two non-limiting examples are given below.

For example it is desired to make a transformer constituted by two plates of thicknesses e₁, e₂ and of area A, the transformer being biased to operate in its second thickness vibration mode. The transformer is fed with a power supply voltage V₁ at a power supply frequency f_{R}. The plates are made of a given material, having a coupling coefficient kₜ, permittivity ε₃₃, a mechanical quality factor Qₘ, density ρ, Young's modulus c₃₃, piezoelectric coefficient e₃₃, and convection coefficient h_{c}. The transformer needs to present gain G close to 1, and deliver power P₂ for a maximum temperature rise Δθ not to be exceeded.

The values of the thicknesses e₁ and e₂ are relatively close when using single-layer plates, since it is difficult for a thin layer to impart movement to a thick layer. Consequently, the gain of the transformer is close to 1. If gain much greater than 1 is desired, it can be preferable to use a multilayer structure in parallel for the secondary, and to adapt the above equations accordingly.

The dimensions of the transformer (A, r=e₂/e₁) are now determined by selecting an operating point Q for the circuit. Two pertinent but non-exclusive selections are described below, however the transformer may equally well be dimensioned for any other type of operating point Q, in particular when there needs to be a compromise between the two examples described below.

In a first example, the power to be transmitted P₂ is known. Two operating points Q₁ and Q₂ can be found constituted by the two roots of the temperature rise equation which is a second-degree polynomial in Q, between which the temperature rise in operation will be below the predefined temperature rise value Δθ. For these two points, the temperature rise of the transformer will be substantially equal to Δθ and the power delivered will be substantially equal to P₂′ Either one of these two points can be used.

$$1 / {Q}_{1 , 2} = \frac{1}{2 {ω}_{R}^{2} / {ω}_{5}^{2}} \{ \frac{2 A}{c} \frac{{h}_{c} Δ θ {Q}_{m}}{{P}_{2}} \pm \sqrt{{( \frac{2 A {h}_{c} Δ θ {Q}_{m}}{{cP}_{2}} )}^{2} - 4 \frac{{ω}_{R}^{2}}{{ω}_{S}^{2}}} \}$$

In this first example, two possible dimensions are obtained for the transformer. It is then possible to select the dimensioning that appears to be the most appropriate, for example the dimensioning that minimizes the volume of the transformer.

In a second example, it may be desired to make an integrated piezoelectric transformer presenting given efficiency for a given temperature rise and given load resistance. An operating point Q₀ may be selected corresponding to optimum efficiency (with this operating point, corresponding to minimum losses, being situated between Q₁ and Q₂).
Q₀=\sqrt{1+1/2c}

In both examples, the area A of the primary and secondary plates and the ratio r=e₂/e₁ of the thickness of the plates can be determined to correspond to said temperature rise Δθ, to said operating point Q, and to said power that is to be transmitted, in particular by using the expressions for G and for P₂. For example, G and P₂ can be expressed as a function of A and the ratio r, with all of the other parameters being known and with the electrical quality factor likewise being expressed as a function of A and of r. The system of equations is solved in an appropriate manner, e.g. numerically or graphically.

Finally, the thickness of each plate is obtained from r together with the total thickness of the transformer eₜₒₜ. For this purpose, said total thickness remains to be determined as follows.

If the transformer 100 is excited at a frequency corresponding to its second mode of vibration, variations are obtained in the stresses c and the displacement d along thickness as shown on the left-hand side of FIG. 3. With this second mode of vibration, stresses are small in the intermediate layer 6 to which the primary and secondary plates 4 and 8 are stuck, which is beneficial in terms of avoiding risks of unsticking. However, the intermediate layer 6 is subjected to maximum displacement.

The mode of vibration can be adapted to the shape of the transformer in thickness in order to satisfy this condition for low stresses in the region where adhesion occurs. This adaptation can be desirable, in particular when the primary and secondary plates 4 and 8 are of thicknesses e₁ and e₂ that are not identical. Nevertheless, it is not absolutely essential for this condition to be satisfied, for example if the adhesive is strong enough.

The total thickness eₜₒₜ is selected so that the power supply frequency f_{R} corresponds to the second mode of vibration of the transformer, thus making it possible, when using two similar plates, to minimize the stresses at the adhesively-bonded interfaces. The total thickness eₜₒₜ of the transformer can thus be selected to be about:
eₜₒₜ=e₁+e₂ (+e₃)=2π/ω_{R}(c₃₃/ρ)^{1/2}

For the materials conventionally used to make the primary and secondary plates, e.g. for lead titanate (M5), the modulus of elasticity in thickness c₃₃ can be of the order of 176 gigapascals (GPa) and the density ρ can be about 7400 kilograms per cubic meter (kg/m³). For vibration at a frequency of about 2.1 megahertz (MHz), a total thickness of about 2.3 mm is obtained, which is compatible with the sizes of the printed circuits that are commonly used for power transistors. For integration purposes, the thickness can be further reduced by using a higher excitation frequency for the transformer. Nevertheless, a compromise is necessary since increasing the frequency leads to an increase in losses.

It is thus possible to dimension a piezoelectric transformer used in a circuit and delivering power P₂ for a maximum allowable temperature rise Δθ. By using the values obtained for A and r in the various equations, it is possible to identify the various values of the components in the equivalent model, and in particular the acceptable load resistances R_{L} lying between the values R_{L1} and R_{L2} corresponding to Q₁ and Q₂. The operating performance of said transformer can also be predicted since the transmission efficiency η, the gain G, and the power transmitted P₂, amongst other things, are associated with the characteristics of the circuit and thus of the material.

For example, particular attention is given to a piezoelectric transformer made up of two similar plates made of lead titanate (M5), i.e. a primary plate and a secondary plate, having a coupling coefficient kₜ=0.5, permittivity ε₃₃=179ε₀ (where ε₀ is the permittivity of vacuum), mechanical quality factor Qₘ=400, piezoelectric coefficient e₃₃=8.5, and convection coefficient h_{c}=15 watts per kelvin per square meter (WK⁻¹m⁻²), the transformer being powered at a frequency f_{R}=2.1 MHz, and transmitting a mean power of P₂₌₁W for a temperature rise less than Δθ=40° C., with inlet and outlet voltages V₁ and V₂ equal to 15 V (G=1). It is desired, for example, to minimize the volume of the transformer.

By selecting Q₁ as the operating point, there are obtained: a total thickness eₜₒₜ=2.3 mm; an area A=164.7 mm²; and a ratio r=0.89 (i.e. about e₁=1.1 mm and e₂=1.2 mm). The efficiency of such a transformer is η=0.89 and the power dissipated in the transformer is 247 milliwatts (mW).

By selecting Q₂ as the operating point, solving the equations gives a ratio r greater than 6, which would give plates of very different thicknesses.

It is also possible to obtain optimum efficiency by selecting Q₀ as the operating point. This gives a total thickness eₜₒₜ=2.3 mm, an area A=1000 mm², and an efficiency of about 0.95. The resulting volume is nevertheless greater than the volume obtained for Q₁.

The material constituting the plates can be selected by implementing this method for various types of available material, e.g. as can be found in a catalog, and by selecting the material that gives the characteristics that are the most suitable for the intended application.

Because of constraints associated with fabricating the transformer (mass production, . . . ), it is naturally possible to use a transformer having dimensions that are close and providing performance that is similar to that described herein. In addition, such dimensioning can also be performed taking account of the intermediate layer 6, the properties of the means for fastening plates to a substrate, or other parameters that have been ignored in this description, should such parameters be of importance in the intended application.

Plates dimensioned in this way for a piezoelectric transformer are prepared and used to make a piezoelectric transformer like the transformer shown in FIG. 4 relating to a first embodiment. The two plates 4 and 8 are secured to opposite sides of an intermediate layer 6 mounted on a rigid support 10 that is secured to an electronic circuit. The primary signal is transmitted to the metallization 7 on the primary plate 4 of the transformer 100, and a secondary signal 9 is transmitted from the secondary plate 8 to a secondary circuit comprising a secondary electronic component 9.

In a second embodiment as shown in FIG. 5, the transformer 100 can be integrated in the electronic circuit 1.

In this example, there is a printed circuit 1, e.g. based on an insulating substrate made of epoxy, alumina, etc. It has a first layer 2, and a second layer 5. The first and second layers 2 and 5 each carry one of the faces of the printed circuit that faces outwards. A primary electronic circuit is made on one of the faces 21 and a secondary electronic circuit is made on the other face 51. These two circuits, the primary circuit and the secondary circuit, are electrically insulated from each other by an intermediate layer 6 constituted by a greater or lesser thickness of the material constituting the primary and secondary layers 2 and 5.

In addition, in the embodiment shown herein, a conductive layer 6a is inserted between the primary and secondary layers 2 and 5. This conductive layer 6a provides an electrostatic screen between the first and second layers 2 and 5.

The primary and secondary circuits carry one or more primary and second electronic components 3 and 9.

The primary and secondary layers 2 and 5 are of thickness lying in the range about 0.5 mm to 2 mm. Each of the first and second layers 2 and 5 presents a preformed recess 13 in which a primary or a secondary plate 4 or 8 is secured.

The primary and secondary plates 4 and 8 possess respective inner faces 42 and 82 facing towards the other plate when the plates are in position in their respective recesses 13. Similarly, the primary and secondary plates 4 and 8 have outer faces 41 and 81 facing away from their inner faces 42 and 82 and lying substantially flush with the primary and secondary circuits respectively of the electronic circuit 1. The primary and secondary plates 4 and 8 are thus placed in such a manner that when viewed in a direction normal to the primary and secondary faces of the electronic circuit 1, the primary and secondary plates 4 and 8 are substantially superposed.

The primary and secondary plates 4 and 8 are also covered over at least a fraction of each of their inner and outer faces 42, 82 and 41, 81 with metallization 7 enabling electrical contact to be made thereto.

The primary and secondary plates 4 and 8 can be fastened in their recesses 13 by co-sintering, for example, by placing a piezoelectric powder, the insulating layer, and the metallization in a mold for fabricating the circuit, and then applying pressure thereto.

Fastening may also be achieved by adhering on the inner faces 42, 82 of the plates when they are made separately on the respective epoxy substrates of the first and second layers 2 and 5. It is preferable to use an adhesive having thermal and mechanical properties that are appropriate for this type of application, specifically, the ability to withstand temperature rises, great hardness, and good behavior when in tension. An epoxy adhesive could be used, for example.

Between the two plates, the intermediate circuit 6 may include a conductive layer 6a. By way of example, the conductive layer can be constituted by copper or by any other material suitable for providing an electrostatic screen.

The primary and secondary plates 4 and 8 as integrated in this way in a printed circuit and as separated by an electrostatic screen constitute an integrated piezoelectric transformer 100.

By way of example, a transformer 100 of the kind shown in FIG. 4 or 5 can be used to implement a function of applying close drive to a power transistor, such as a MOSFET, an IGBT, or any other power semiconductor, and to do so with excellent isolation.

To this end, the primary plate 4 is connected to a primary circuit having components that are secured to the first layer of the printed circuit, for example (such as the electronic component 3 shown in FIGS. 4 and 5). The secondary plate 8 is connected to a secondary circuit, whose components are integrated, for example, on the second layer 5 of the printed circuit (such as the electronic component 9 of FIG. 1).

In order to achieve adequate efficiency, the transformer 100 must be driven by an oscillator at a frequency f_{R}, which may be constituted by one of its resonant frequencies, for example (in particular its second mode of vibration in thickness, which is of the order of a few megahertz, for example). This frequency is generally not associated with the frequency of the signal driving the gate of the transistor to switch the transistor on and off, which frequency may be kilohertz (kHz) order, or of the order of about 10 kHz, for example.

It is possible to use a module, e.g. an HEF4013 module from the supplier Philips, or the like, that transmits the drive signal, e.g. by full-wave modulation at the frequency of mechanical resonance f_{R} of the transformer 100, which frequency can be selected to be much greater than the frequency of the drive signal.

The modulated signal as transmitted in this way to the integrated transformer is recovered from the secondary plate 8 and must be demodulated in order to enable a reliable close drive device to be made. The signal recovered from the secondary plate 8 is likewise at the frequency f_{R}. This signal can be rectified in conventional manner, for example, using a diode bridge, and demodulated using a demodulator, which detects the envelope of the output signal.

Alternatively, amplitude modulation can be performed at two levels, or frequency modulation at two frequencies. Under such circumstances, the piezoelectric transformer can be powered by an alternating signal capable of taking two different frequencies. For example, modulation is obtained by a multiplier controlled by the drive signal, transmitting one or the other of two signals at neighboring frequencies, as issued by oscillators.

Appropriate demodulation of the signal transmitted by the secondary plate can consist, for example, in using a phase-locked loop (PLL) delivering a voltage proportional to the transmitted frequency, or using any other appropriate means. This alternative makes it possible to vary the duty ratio of the signal between 0 and 1. Other modulation/demodulation systems can be applied to such a transformer.

1. A method of making designing a piezoelectric transformer comprising a primary plate and a secondary plate the method comprising:
designing at least one geometrical parameter of the plates or at least one physical parameters of a material constituting the plates or a combination of at least one geometrical parameter of the plates and at least one physical parameter of the material by taking into account an expression for heat dissipated due to losses in the transformer.

2. A method according to claim 1, in which the following steps are performed:
as a function of said geometrical and/or physical parameters, estimating:
the losses of the transformer; and
a maximum acceptable temperature rise;
determining an operating range for the transformer corresponding to a condition whereby the transformer losses are less than a maximum acceptable quantity of heat corresponding to said temperature rise; and
determining at least the ratio (r) of the thicknesses of the first and second plates and the area (A) of at least one of the plates for an operating point (Q) selected in said operating range of the transformer.

3. A method according to claim 2, in which the losses of the transformer are estimated as being
P₂(1−η)/η
where P₂ is the power transmitted by the transformer, η is the efficiency of the transformer, and where P₂ and η are expressed as a function of said parameters.

4. A method according to claim 2, in which said quantity of dissipated heat is estimated as being
h_{c}SΔθ
where h_{c} is a coefficient specific to a material constituting the transformer, S is a heat exchange area that is a function in particular of the geometrical parameters of the plates, and Δθ is said maximum acceptable temperature rise.

5. A method according to claim 2, in which said operating range extends between two limit operating points (Q₁, Q₂) corresponding to losses that are substantially equal to said maximum acceptable quantity of heat.

6. A method according to claim 5, in which an operating point (Q) is selected corresponding to a minimum area for at least one plate and to said maximum acceptable quantity of heat.

7. A method according to claim 5, in which a characteristic of the model selected from efficiency (η), gain (G), power transmitted by the transformer (P₂), and any combination thereof, is expressed as a function of the operating point (Q), and in which the operating point is selected as being an intermediate operating point corresponding to a given value for said characteristic.

8. A method according to claim 7, in which the selected operating point (Q₀) is the point corresponding to an optimum value for said characteristic.

9. A method according to claim 2, in which the transformer is to present at least one known characteristic selected from at least the gain (G), the transmitted power (P₂), the efficiency (η), and combinations thereof, and in which a system of equations is solved that comprises at least said known characteristic and an unknown parameter of the transformer for said selected operating point (Q).

10. A method according to claim 2, in which the transformer is designed to be powered by a primary electrical signal at a power supply frequency (f_{R}), in which a total thickness (eₜₒₜ) for the transformer is determined so that the power frequency is a mechanical resonant frequency of the transformer, and in which the thickness (e₁, e₂) of each plate is determined on the basis of the total thickness (eₜₒₜ) and the ratio (r) of the thicknesses.

11. A method according to claim 1, in which a material for constituting the plates is selected by implementing successively the steps of the method for at least two distinct materials having known physical parameters.

12. A method according to claim 1, further comprising the following steps:
assembling said two plates on either side of an intermediate layer of the transformer, said intermediate layer comprising an electrically insulating material; and
applying primary and secondary metallization to said plates, the primary metallization being for connection to a primary circuit and the secondary metallization being for connection to a secondary circuit.

13. A method according to claim 12, in which said intermediate layer comprises an electrostatic screen.

14. A method according to claim 12, in which the primary and secondary plates are respectively integrated in first and second layers of a substrate of a material selected from printed circuit material, ceramic material, and semiconductor material, and respectively supporting a primary printed circuit and a secondary printed circuit, the first and second layers being disposed respectively on either side of an intermediate circuit layer having at least a portion that forms the intermediate layer of the transformer.

15. A method according to claim 12, in which the intermediate layer of the transformer is mounted on a rigid support secured to an electronic circuit medium supporting said primary circuit and said secondary circuit.

16. A method according to claim 13, wherein the primary and secondary plates are respectively integrated in first and second layers made in a substrate of material selected from printed circuit material, ceramic material, and semiconductor material, and respectively supporting a primary printed circuit and a secondary printed circuit, and
the first and second layers being disposed respectively on either side of an intermediate circuit layer having at least a portion that forms the intermediate layer of the transformer.

17. A method according to claim 13, wherein the intermediate layer of the transformer is mounted on a rigid support secured to an electronic circuit medium supporting said primary circuit and said secondary circuit.

18. A method of designing a piezoelectric transformer comprising:
designing primary and secondary plates of the transformer such that a thickness of the plates, a surface area of the plates and a material from which the plates are fabricated, all are determined by taking into consideration heat dissipation as a result of power loss during operation of the transformer and a maximum acceptable operating temperature of the transformer;
assembling said two plates on either side of an intermediate layer of the transformer, said intermediate layer comprising an electrically insulating material; and
applying primary and secondary metallization to said plates, the primary metallization being for connection to a primary circuit and the secondary metallization being for connection to a secondary circuit;
wherein the intermediate layer of the transformer is mounted on a rigid support secured to an electronic circuit medium supporting said primary circuit and said secondary circuit.

19. A method according to claim 18, wherein said intermediate layer comprises an electrostatic screen.

20. A method according to claim 19, wherein the plates are respectively integrated in first and second layers of a substrate of a substrate material selected from printed circuit material, ceramic material, and semiconductor material, and respectively supporting a primary printed circuit and a secondary printed circuit, the first and second layers being disposed respectively on either side of an intermediate circuit layer having at least a portion that forms the intermediate layer of the transformer.
